(19) United States
(12) Patent Application Publication
(10) Pub. No.: US 2006/0190501 A1
(43) Pub. Date: Aug. 24, 2006

(54) System supporting data repository compatibility

(76) Inventor: Sandy Massironi, Downingtown, PA (US)

Correspondence Address: Siemens Corporation;Intellectual Property Department, 170 Wood Avenue South, Iselin, NJ, 08830, US

(21) Appl. No.: 11/325,877

(22) Filed: Jan. 5, 2006

Related U.S. Application Data
(60) Provisional application No. 60/654,419, filed on Feb. 18, 2005.

(51) Int. Cl. G06F 17/30

(52) U.S. Cl. 707/203

(57) ABSTRACT

A system addresses backward compatibility between two databases by capturing the latest definition and structure of a referenced model database and providing the information for use in creating object information usable by a database management application of a first database for accessing data in a different second database and that supports compatible operation following a version upgrade of either or both the database management application and the second database. A system for providing compatibility between different first and second databases includes a repository of first object information. The first object information indicates characteristics of a first version of a second database including, a data structure, data objects accessed by a management application of a first database and associated properties of the data objects. A data processor uses the first object information in generating second object information by incorporating in the second object information, data objects acquired from a second version of the second database. The second object information being for use by the management application of a first database in accessing data objects from the second version of the second database.

This is a non-provisional application of provisional application Ser. No. 60/654,419 by S. Massironi filed Feb. 18, 2005.

### FIELD OF THE INVENTION

This invention concerns a system for enabling compatibility including backward compatibility between different first and second databases for use in database upgrade and application integration.

### BACKGROUND OF THE INVENTION

It is commonly required that an already deployed version of a database be upgraded or operated in conjunction with, a new version of a database structure and associated content. In such a situation it is often necessary to maintain backward compatibility between new and prior versions of the databases. A typical method employed by an existing system for integrating two different database structures involves maintaining an integration layer that is able to read different versions of a referenced database and return a common result set to a referencing database.

In such an existing system, integration code implementing an integration layer needs to be provided supporting each release of executable application software using either a prior or new version database and ensuring operational compatibility between prior and new versions. This also requires that integration code needs to be provided when either the prior version or new version of the database is upgraded. It is also necessary to coordinate the update of the integration code with upgrade of either the prior version or new version of the database as well as with upgrade of an associated application such as a database management application system (a DBMS). This creates a burden and a timing problem that is difficult to manage. A system according to invention principles addresses these burdens and related problems.

### SUMMARY OF THE INVENTION

A system supports backward compatibility between two databases by creating object information usable by a database management application of a first database for accessing data in the first database and a different second database and that supports compatible operation following a version upgrade of either or both the database management application and the second database. A system for providing compatibility between different first and second databases includes a repository of first object information. The first object information indicates characteristics of a first version of a second database including, a data structure, data objects accessed by a management application of a first database and associated properties of the data objects. A data processor uses the first object information in generating second object information by incorporating in the second object information, data objects acquired from a second version of the second database. The second object information being for use by the management application of a first database in accessing data objects from the second version of the second database.

### BRIEF DESCRIPTION OF THE DRAWING

FIG. 1 shows an overview of a database arrangement including a database update system, according to invention principles.

FIG. 2 shows elements and a flowchart of a process used by a system for providing compatibility between different databases, according to invention principles.

FIG. 3 illustrates upgrade of a referenced database, according to invention principles.

FIG. 4 illustrates upgrade of a referencing database, according to invention principles.

FIG. 5 shows a flowchart of a process used by a database update system for generating object information supporting compatibility between different databases, according to invention principles.

FIG. 6 shows use of generated object information to enable compatibility between updated different databases, according to invention principles.

FIG. 7 shows a flowchart of a process employed by a database update system, according to invention principles.

### DETAILED DESCRIPTION OF THE INVENTION

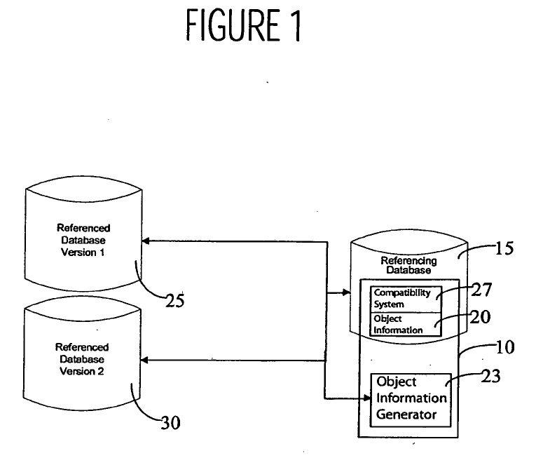

FIG. 1 shows an overview of a database arrangement including a database update system. The database update system supports integration of two databases and accommodates version upgrades in one or both of the databases as well as a version upgrade in a database management application managing access to one or more databases. Specifically, the database update system enables a database management application that governs access to a referencing (first) database to access data objects in a referenced (second) database following a version upgrade of one or both of the databases or a database management application. Thereby the database update system enables a database management application to operate compatibly both with a database version at a first site containing additional objects and with a prior database version at a second site that does not contain the additional objects, for example. This is a commonly occurring situation resulting from variation in timing of database upgrades.

The database update system addresses the problem of enabling backward compatibility between two databases by capturing a latest definition (indicating content data format and structure) of a referenced model database and providing information about the data structures in the referenced model database to be used in conjunction with prior versions of the referenced database employing a different content data format and structure. Object information (e.g., identifying objects in different versions of a database) is created in a referencing first database. The database update system supplements the object information with information acquired concerning content data format and structure of a referenced second model database (i.e., a later or earlier definition of the referenced second model database). Thereby the database update system generates object information indicating a content data format and structure of a referenced second model database even when this model structure does not exist at a particular site and has yet to be implemented at the site. The generated object information advantageously creates a common data structure for the content of different versions of the first database and second database and is used in accessing data from the second database.

The system advantageously enables use of a single set of executable code for integrating different combinations of releases of a referencing first database and a referenced second database. As a result, additional integration software does not need to be delivered upon upgrade of a referenced second database or referencing first database. Further, upgrade of a referencing first database involves generating and including a model definition in the referencing database. This model definition indicates content data format and structure of a referenced second database and optionally indicates content data format and structure of other versions of a referencing first database. This advantageously reduces code required to be generated and tested to handle backward compatibility and allows more flexibility in timing of database upgrades.

FIG. 1 shows an overview of a database arrangement including a database access system 10. System 10 captures and provides object information 20 comprising a definition of objects that are within model referenced second database 25 (and optionally in referencing first database 15). The object information is used to supplement information in referencing first database 15 at a user site, for example, to enable access by referencing first database 15 to a referenced database 30 at the user site. The object information enables access to database 30 at the user site even though databases 15 and 30 versions are not integrated and directly compatible, for example. The system employs a set of executable code 23 that accesses data in model referenced second database 25, irrespective of its structure, and creates object information 20 comprising a definition of objects that are within the model referenced database 25 and referenced database 30 e.g., a prior version of database 25. Object information 20 advantageously creates a common data structure for the content of different database versions, specifically for second database 25 and database 30. Compatibility system 27 in system 10, accesses (i.e. references) data in database 30 through the generated object information 20, in response to a data access request. The system eliminates the need for release specific code to be part of an integration object because it is dynamically generated from an actual database and associated model database definition.

An executable application as used herein comprises code or machine readable instruction for implementing predetermined functions including those of an operating system, healthcare information system or other information processing system, for example, in response user command or input. An executable procedure is a segment of code (machine readable instruction), sub-routine, or other distinct section of code or portion of an executable application for performing one or more particular processes and may include performing operations on received input parameters (or in response to received input parameters) and provide resulting output parameters. A processor as used herein is a device and/or set of machine-readable instructions for performing tasks. A processor comprises any one or combination of, hardware, firmware, and/or software. A processor acts upon information by manipulating, analyzing, modifying, converting or transmitting information for use by an executable procedure or an information device, and/or by routing the information to an output device. A processor may use or comprise the capabilities of a controller or microprocessor, for example.

A display processor or generator is a known element comprising electronic circuitry or software or a combination of both for generating display images or portions thereof. A user interface comprises one or more display images enabling user interaction with a processor or other device. Executable code (or code) comprises executable machine readable instruction. An object comprises a data element and associated properties within a database. Object information comprises a definition of objects that are within a database indicating content data format of objects and the structure of the database. The terms, upgrade and update, are used interchangeably to indicate replacement of a first version of content data format and/or structure of a database to a second different version of content data format and/or structure of the database. A database version as used herein is a newer or older version of a database structure or content and such content includes data format or data type, or data element values. A version of a database also encompasses a related database or similar database. First and second versions of a database are also used herein to encompass databases having at least a portion of common content or data structure.

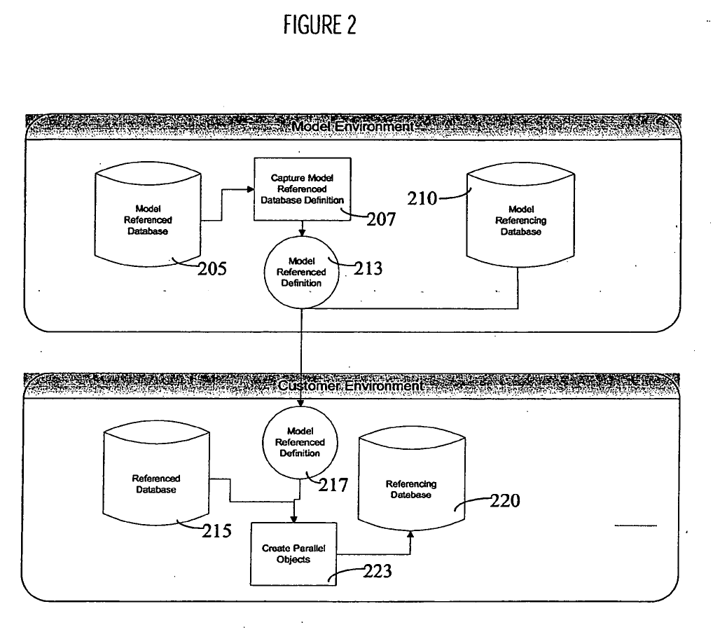

FIG. 2 shows elements and a flowchart of a process used by system 10 (FIG. 1) for providing compatibility between different databases. System 10 in step 207 captures a model definition indicating content data format and structure of referenced database 205 to provide captured definition 213. In one embodiment system 10 also captures a model definition indicating content data format and structure of referencing database 210 for inclusion in captured definition 213. System 10 provides database definition 217 corresponding to captured definition 213, to a remote site. The remote site, for example, is a customer site including referenced database 215 comprising a version of referenced database 205 and including referencing database 220 comprising a version of referenced database 210. System 10 employs database definition 217 in generating object information 223 comprising a definition of objects that are within referenced database 215 (and optionally in referencing database 220). Referencing database 220 accesses data in referenced database 215 via object information 223, enabling database 215 to imitate the content data format and structure of model referenced database 205. A database management application managing referencing database 220 requests data from object information 223 and receives response data in a data format and structure compatible with model referenced database 205. In one embodiment system 10 employs object information 223 to translate a data request into a data format and structure compatible with model referencing database 210 and uses the translated request for accessing data via object information 223.

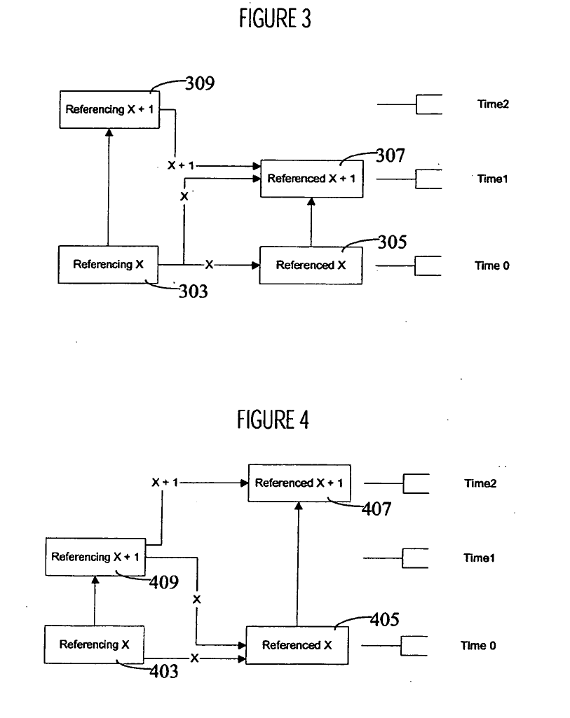

FIGS. 3 and 4 show two different database upgrade scenarios. In FIGS. 3 and 4 identifiers X and X+1 identify version levels of integrated databases. Specifically, referencing database X and referenced database X are the first versions of these databases to be integrated together and referencing database X+1 and referenced database X+1 are the subsequent versions of these databases to be integrated together. FIG. 3 illustrates upgrade of referenced database X 305 to version X+1 prior to upgrade of referencing database X 303 to version X+1. At time 0, installation and integration of referencing database X 303 and referenced database X 305 occurs. At time 1, upgrade of referenced database X 305 to version X+1 307 occurs but the integration level remains as X. The integrated combination of referencing database X 303 and referenced database X+1 307 continues to acquire released upgrade definitions at version X until the referencing database X 303 is updated to referencing database X+1 309 (a release version level that compatibly integrates with referenced database X+1 307). At time 2, upgrade of referencing database X 303 to version X+1 309 and acquisition of released upgrade definitions at version X+1 occurs. A problem occurs with the intermediate upgrade condition at time 1 which may lead to incompatibility between referencing database X 303 and referenced database X+1 307. Specifically, for example, referenced database X+1 307 may use a data column length that is incompatible with data access requests by referencing database X 303 and exceeds an existing column length employed at the version X integration level.

FIG. 4 illustrates upgrade of referencing database X 403 to version X+1 prior to upgrade of referenced database X 405 to version X+1. At time 0, installation and integration of referencing database X 403 and referenced database X 405 occurs. At time 1, upgrade of referencing database X 403 to version X+1 409 occurs but the integration level remains as X. The integrated combination of referencing database X+1 409 and referenced database X 405 continues to acquire released upgrade definitions at version X until the referenced database X 405 is updated to referenced database X+1 407 (a release version level that compatibly integrates with referencing database X+1 409). At time 2, upgrade of referenced database X 405 to version X+1 407 and acquisition of released upgrade definitions at version X+1 occurs. A problem occurs with the intermediate upgrade condition at time 1 which may lead to incompatibility between referencing database X+1 409 and referenced database X 405. Specifically, for example, referencing database X+1 409 may use added columns that are incompatible with referenced database X 405 so that data access requests by referencing database X+1 409 may attempt to access data columns that do not yet exist in referenced database X 405.

System 10 of FIG. 1 advantageously addresses the problems identified in connection with FIGS. 3 and 4. For this purpose system 10 catalogs individual objects that are to be integrated between referencing first database 15 and model referenced second database 25. In order to do this, during development of referencing first database 15, an SQL stored procedure is created (in unit 23) and used by system 10 to read a definition of individual cataloged objects in model referenced second database 25 and extracts information about the cataloged objects (e.g., column, data type and length) for individual objects. System 10 (unit 23) captures the extracted information and stores it in a cataloged objects data set to be delivered to users during upgrades of referencing first database 15. An SQL stored procedure is also created for use in system 10 unit 23 and executed at a user site that employs as input both, a definition of cataloged objects in referenced database 30 created at the user site, together with the previously created cataloged objects data set, in order to create a parallel object definition (object information 20). Object information 20 incorporates both the users referenced database 30 definition as well as model referenced second database 25 definitions. Referencing first database 15 accesses data in referenced database 30 through the object information using unit 27, this ensures one set of code is compatible with any version of referenced database 30. In one embodiment in the event that referencing first database 15 accesses an inconsistent data type in referenced database 30, object information 20 uses a data format type provided by referenced database 30. System 10 in this embodiment assumes that different database 30 versions are unlikely to employ radically different data format type other than different data element length. In another embodiment system 10 uses substitute placeholder (e.g., null or blank) data upon detecting an inconsistent data type.

System 10 captures and provides to a user site, a new data file that contains an extract of the definition of each of the columns of tables referenced in model referenced second database 25, for example, as part of a process of integrating an upgrade of referencing first database 15 with referenced database 30. System 10 automatically (or in another embodiment in response to user command) modifies an SQL stored procedure in unit 23 that creates object information 20 in order to add columns delivered in the new data file that are absent in a corresponding table in referenced database 30. Unit 23 employs appropriate default values for the added columns in object information 20. System 10 modifies an installation process to redefine objects that are to be accessed by referencing first database 15 from referenced database 30 in response to upgrade of referencing first database 15 or referenced database 30. An executable procedure 23 creates object information 20 including the redefined (integrated) objects using a current system catalog of referenced database 25 to define the lengths of objects. This ensures that integrated objects are rebuilt with the latest column definition in case of a data type length change that occurred during an upgrade of model referenced second database 25.

System 10 advantageously requires reduced ongoing maintenance to integrate multiple releases of referenced and referencing databases. The new data file, comprising a definition of model referenced database 25 delivered with an upgrade of referencing database 15, for example, is used to generate object information 20 that makes referenced database 30 appear to have the structure of model referenced database 25. Additionally, if multiple referenced databases exist and they are individually running a different version of the referenced database software, a consistent model database structure is generated using object information 20 enabling a referencing database to access the multiple referenced databases regardless of their version.

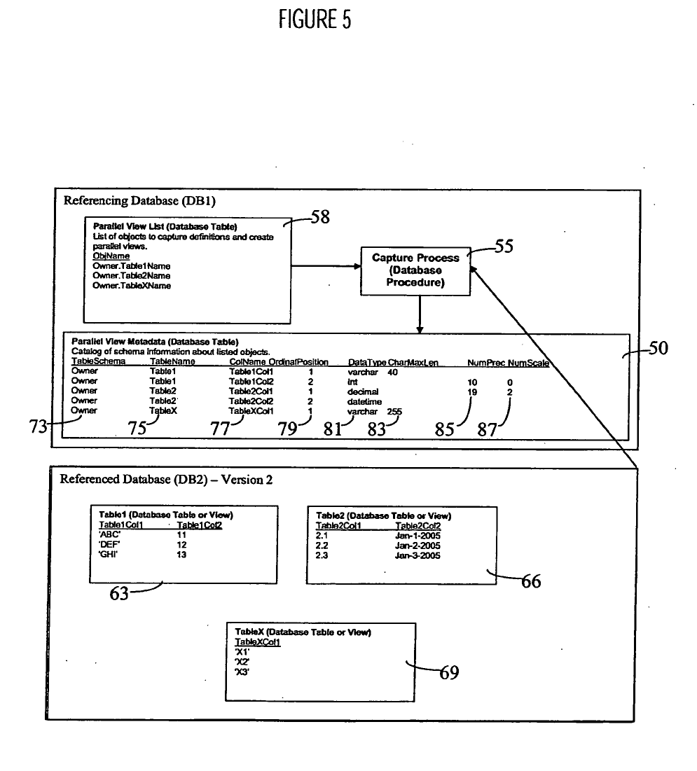

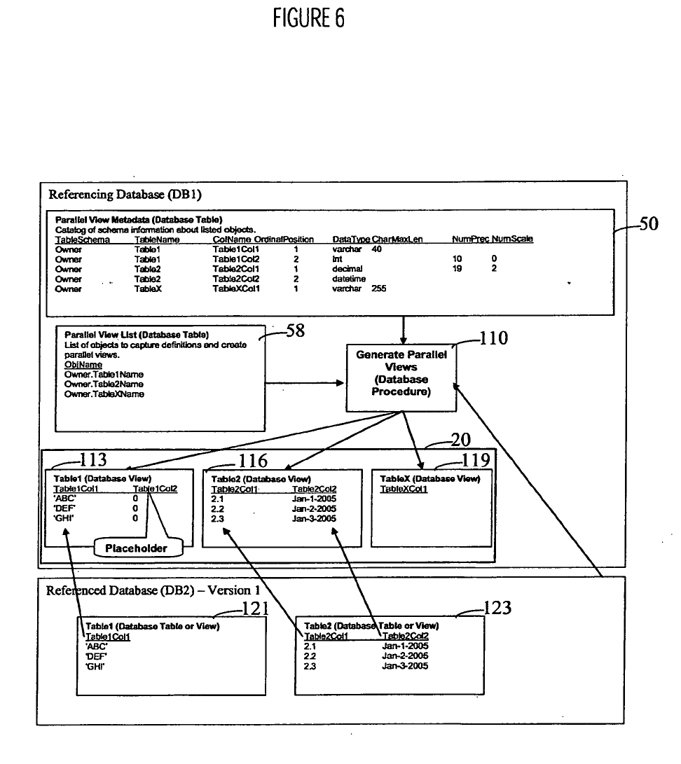

FIGS. 5 and 6 together illustrate a single example of system 10 operation. FIG. 5 shows a flowchart of a process used by system 10 for generating object information 20 supporting compatibility between different databases. In preparation for release of a database DB1, system 10 acquires catalog information comprising a list of objects 58 from referencing database DB1 for use in capturing database definition information indicating data format and structure of a referenced database DB2 version 2. The list of objects 58 indicates objects accessed from referenced database DB2 version 2 by referencing database DB1 (including objects Owner.Table1Name, Owner.Table2Name, Owner.TableXName). System 10 executes a process 55 using the list of objects 58 to read a definition of individual objects in DB2 version 2 and compile a cataloged objects dataset 50 comprising tabular information, for example. System 10 executes a process 55 using the list of objects 58 to read a definition of individual objects in Table1 (item 63), Table2 (item 66) and TableX (item 69) in DB2 version 2 corresponding to the objects Owner.Table1Name, Owner.Table2Name, Owner.TableXName identified in list 58. Compiled cataloged objects dataset 50 comprises tabular information including TableSchema identifier 73, TableName 75, Column Name 77, Ordinal Position in Table 79, Data Type identifier 81, Character maximum length of value of item in table 83, Numeric Precision of value of item 85 and Numeric Scale 87. In subsequent release updates of database DB1 (or DB2) system 10 revises list of objects 58 and re-executes process 55 to compile a new cataloged objects dataset 50.

FIG. 6 shows use of generated object information to enable compatibility between updated different databases. The cataloged objects dataset 50 and list of objects 58 is provided together with the release of referencing database DB1 to a user site employing referenced database DB2 version 1 (a version prior to version 2). Upon delivery of the release of database DB1, system 10 executes a process 110 that uses the list of objects 58 and cataloged objects dataset 50 to read a definition of individual objects in DB2 version 1 and compiles object information 20. Object information 20 enables referencing database DB1 to be compatible with referenced database DB2 version 1 and version 2. Process 110 reads a definition of individual objects in tables 121 and 123 in DB2 version 1 and creates object information 20 comprising Tables 113, 116 and 119 using cataloged objects dataset 50.

Process 110 creates an object information 20 data structure including Tables 113, 116 and 119 (corresponding to Tables 63, 66 and 69 of FIG. 5) to provide the data structure indicated by cataloged objects dataset 50 and populates Tables 113, 116 and 119 with individual objects derived from tables 121 and 123 in DB2 version 1. Process 110 creates placeholder columns in object information 20 for columns that are indicated as being present by dataset 50 (i.e., are present in referenced database DB2 version 2) but are absent from referenced database DB2 version 1 (e.g., Table1Col2 of Table 113 is a created Placeholder column). Process 110 populates created placeholder columns and fills in missing data (i.e., data that is not present in referenced database DB2 version 1) with appropriate default data, such as the zero values used to populate column Table1Col2 of Table 113. Process 110 also creates empty structures for missing objects, i.e., object structures such as Table 119 in object information 20 which corresponds to Table 69 in referenced database DB2 version 2 but for which there is no counterpart in referenced database DB2 version 1. Object information 20 is used by the release of referencing database DB1 that is compatible with referenced database DB2 version 2 to access data in prior version, specifically version 1 of referenced database DB2.

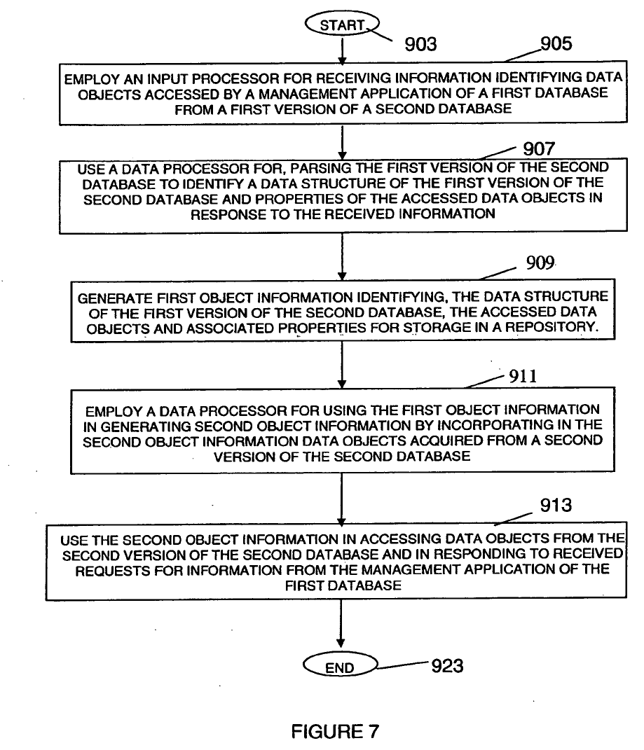

FIG. 7 shows a flowchart of a process employed by database access system 10. In step 905 following the start at step 903, an input processor in system 10 (FIG. 1) receives information identifying data objects accessed by a management application of first referencing database 15 from a first version of second referenced database 25. A data processor in system 10 in step 907, parses the first version of the second referenced database 25 to identify a data structure of the first version of the second referenced database 25 and properties of the accessed data objects in response to the received information. The properties of the accessed data objects include, number of data columns, individual data element type (e.g., determining whether a data element is of variable or fixed data length), individual data element length, column relative position in a table and table identifier. In step 909 a data processor generates first object information identifying, the data structure of the first version of the second database, the accessed data objects and associated properties for storage in a repository. A data object comprises data, comprising or identifying, a table of data elements, a column of data elements, a row of data elements or a data element.

In step 911, a data processor uses the first object information in generating second object information by incorporating in the second object information, data objects acquired from a second version of the second referenced database 30. The data processor generates the second object information 20 by parsing the second version of the second referenced database 30 to identify data objects identified in the first object information and having properties compatible with requirements identified in the first object information and to identify the acquired data objects. The data processor incorporates in the second object information 20, executable instructions for substituting placeholder data for data objects identified in the first object information absent from the second version of the second database 30. The first version of the second referenced database 25 is a newer version than the second version of the second referenced database 30. The second object information 20 includes placeholder information for data objects accessed by a management application of the first referencing database 15 from the first version of the second referenced database 25 that are absent from the second version of the second referenced database 30. In step 913 the data (or response) processor (including the management application of first referencing database 15, for example) uses the second object information 20 in accessing data objects from the second version of the second referenced database 30 and in responding to received requests for information from the management application of the first referencing database 15. The process of FIG. 7 terminates at step 923.

The system and processes presented in FIGS. 1-7 are not exclusive. Other systems and processes may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. Further, any of the functions provided by the systems and processes of FIGS. 1-7 may be implemented in hardware, software or a combination of both. System 10 is usable by a business that needs to integrate multiple databases that require upgrades to occur on independent cycles. System 10 provides backward compatibility in the integration of a Financial and a clinical referenced database with a Decision Support System using a Referencing database to allow support of more than one version of the Financial database, for example. System 10 supports asynchronous upgrade of the Financial referenced database and referencing database of the Decision Support System, for example.

What is claimed is:

1. A system for providing compatibility between different first and second databases, comprising:
a repository of first object information indicating characteristics of a first version of a second database including,
a data structure,
data objects accessed by a management application of a first database and
associated properties of said data objects; and
a data processor for using said first object information in generating second object information by incorporating in said second object information, data objects acquired from a second version of said second database, said second object information being for use by said management application of said first database in accessing data objects from said second version of said second database.

2. A system according to claim 1, wherein
said second object information includes placeholder information for data objects accessed by said management application of said first database from said first version of said second database that are absent from said second version of said second database.

3. A system according to claim 1, wherein
said first version of said second database is a newer version than said second version of said second database.

4. A system according to claim 1, wherein
said data processor generates said second object information by parsing said second version of said second database to identify said acquired data objects.

5. A system according to claim 1, wherein
said data processor generates said second object information by
parsing said second version of said second database to identify data objects identified in said first object information and having properties compatible with requirements identified in said first object information.

6. A system according to claim 5, wherein
said data processor generates said second object information by
incorporating in said second object information, executable instructions for substituting placeholder data for data objects identified in said first object information absent from said second version of said second database.

7. A system according to claim 1, wherein
a data object comprises data, comprising or identifying, at least one of, (a) a table of data elements, (b) a column of data elements and (c) a row of data elements.

8. A system according to claim 1, wherein
a data object comprises data, comprising or identifying, a data element.

9. A system according to claim 1, including
a response processor for using said second object information in accessing data objects from said second version of said second database and responding to received requests for information from said management application of said first database.

10. A system according to claim 1, wherein
said properties of said accessed data objects include, number of data columns, individual data element type and individual data element length.

11. A system according to claim 1, wherein
said properties of said accessed data objects include, column relative position in a table and table identifier.

12. A system for supporting providing compatibility between different first and second databases, comprising:
an input processor for receiving information identifying data objects accessed by a management application of a first database from a first version of a second database; and
a data processor for,
parsing said first version of said second database to identify a data structure of said first version of said second database and properties of said accessed data objects in response to said received information and
generating first object information identifying, said data structure of said first version of said second database, said accessed data objects and associated properties for storage in a repository.

13. A system according to claim 12, including
a data processor for using said first object information in generating second object information by incorporating in said second object information, data objects acquired from a second version of said second database, said second object information being for use by said management application of said first database in accessing data objects from said second version of said second database.

14. A system according to claim 12, wherein
said properties of said accessed data objects include, number of data columns, individual data element type and individual data element length.

15. A system according to claim 14, wherein
said data element type determines whether a data element is of variable or fixed data length.

16. A system for providing compatibility between different first and second databases, comprising:
a repository of first object information indicating characteristics of a first version of a second database including,
a data structure,
data objects accessed by a management application of a first database and
associated properties of said data objects; and
a data processor for,
using said first object information in generating second object information by incorporating in said second object information, data objects acquired from a second version of said second database, said second object information being for use by said management application of said first database in accessing data objects from said second version of said second database and
using said second object information in accessing data objects from said second version of said second database and responding to received requests for information from said management application of said first database.
